(19) United States
(12) Patent Application Publication
(10) Pub. No.: US 2002/0009222 A1
(43) Pub. Date: Jan. 24, 2002

(54) Method and system for viewing kinematic and kinetic information

(76) Inventors: Chris A. McGibbon, Belmont, MA (US); David E. Krebs, Cambridge, MA (US); Niyom Lue, Nahant, MA (US)

Correspondence Address: LAHIVE & COCKFIELD, 28 STATE STREET, BOSTON, MA, 02109, US

(21) Appl. No.: 09/819,114

(22) Filed: Mar. 27, 2001

Related U.S. Application Data
(60) Provisional application No. 60/192,602, filed on Mar. 27, 2000.

(51) Int. Cl. G06K 9/00; G06K 9/36

(52) U.S. Cl. 382/154; 382/276

(57) ABSTRACT

A system and method for displaying kinematic and kinetic information of a subject is provided. The system includes an image input stage for acquiring image data of the subject, a transformation stage for transforming the image data into three dimensional coordinates corresponding to one or more body segments of the subject, and an output data stage for calculating the kinematic and kinetic information of the subject from the three dimensional coordinates. The system can also include a user interface for displaying the calculated kinematic and kinetic information of the subject.

### FIELD OF THE INVENTION

The present invention relates generally to a system and method for analyzing kinetic and kinematic information of human motion, and for viewing the information.

### BACKGROUND OF THE INVENTION

Modern human movement analysis began with Eadweard Muybridge in the late 1800's. Muybridge was the first to capture human movement using stop-action photography, a process fundamental to today's modern tracking technology. Unlike Muybridge's system, modem video and optoelectric motion capture systems are fast, accurate and reliable, and have applications extending from use in hospitals and clinics to the high-tech entertainment industry. While the entertainment industry is mostly concerned with the qualitative aspects of human movement, for example how bodies look when in motion, the medical field's primary concern remains quantitative. Indeed, an entire industry has been built to furnish hospitals and clinics with sophisticated movement capture technology.

While the hardware aspects of this industry have grown exponentially, the software aspects have, in general, lagged considerably. As such, many clinical and research motion analysis labs develop proprietary software for analyzing the kinematics (movements) and kinetics (forces) of human movement. Consequently, the field is presently populated by unstandardized movement data, and in some cases errors in computations or reasoning that unfortunately can go undetected.

Today, the major vendors in the industry provide analysis software with their data capture systems. The adjunct software applications, however, are strictly tied to the hardware systems, and are not available to the field as stand alone applications. Many of these software applications also do not describe human movement in terms of skeletal movement, but in terms of movement of external markers placed on the body. This, at best, provides only an approximation of skeletal movements. It is the skeletal movements that are clinically relevant.

### SUMMARY OF THE INVENTION

The present invention addresses these drawbacks by providing a full four-dimensional analysis (three space dimensions, one time dimension) of human movement data captured by a motion analysis system. The invention enables detailed biomechanical analysis of human movement data, as well as the visualization of data. The analysis is current and compliant to the present demand for more sophisticated analysis tools. The present invention greatly reduces the time required for clinical labs to produce reports for patient's principal care providers, and in reducing vast amounts of data for large research projects, such as clinical trials aimed at improving patient function. More importantly, the present invention incorporates industry standards of describing human movement, thus, providing a powerful analysis tool that is independent of current analysis hardware.

The present invention addresses the above-described limitations by providing a software facility for computing and displaying kinematic and kinetic information to a user.

This approach provides an uncomplicated method of analyzing various human movements. According to one aspect, a system for displaying kinematic and kinetic information of a subject is provided. The system includes an image input stage for acquiring image data of the subject, a transformation stage for transforming the image data into three dimensional coordinates corresponding to one or more body segments of the subject, and an output data stage for calculating the kinematic and kinetic information of the subject from the three dimensional coordinates. The system can also include a user interface for displaying the calculated kinematic and kinetic information of the subject.

According to another aspect, a method for displaying kinematic and kinetic information of a subject is also provided. The method comprises the steps of acquiring image data of the subject, transforming the image data into three dimensional coordinates corresponding to one or more body segments of the subject, and calculating the kinematic and kinetic information of the subject from the three dimensional coordinates.

### BRIEF DESCRIPTION OF THE DRAWINGS

The aforementioned features and advantages, and other features and aspects of the present invention, will be understood with reference to the following description and accompanying drawings; wherein:

FIG. 1 illustrates a schematic block diagram of a system for analyzing kinetics and kinematics of motion;

FIG. 2 is a schematic representation of the human modeling performed by the present invention;

FIG. 3 is a schematic flowchart diagram illustrating the method performed by the image input stage to acquire image information;

FIG. 4 is a schematic block diagram of the transformation stage of FIG. 1 for and building a 3-D human body model according to the features of the present invention;

FIG. 5 is a schematic flowchart diagram illustrating the creation of the tracking module;

FIG. 6 is a schematic flowchart diagram illustrating the operation the full body modeling module;

FIG. 7 is a schematic block diagram of the output data stage;

FIG. 8 is a schematic block diagram of the kinematic analysis module;

FIG. 9 is a schematic block diagram of the kinetic analysis module; and

FIG. 10 is a schematic block diagram of the user interface.

### DETAILED DESCRIPTION

The illustrative embodiment of the present invention provides a system and method, and a software facility, for the analysis of kinematics and kinetics of human movement. The present invention utilizes an eleven segment three-dimensional model of human movement analysis. In particular, the present invention provides for six degrees of freedom (DOF) for each body segment, for a total of sixty six (66) DOF. Also, a user interface is provided to demonstrate the kinetics and kinematics of human movement. Those of ordinary skill will recognize that the present invention provides the ability to track other various human movements and model such movements. The system of the invention can also include the ability to monitor selected input or system signals, such as electromyographic, electrostagmographic, and other analog type signals.

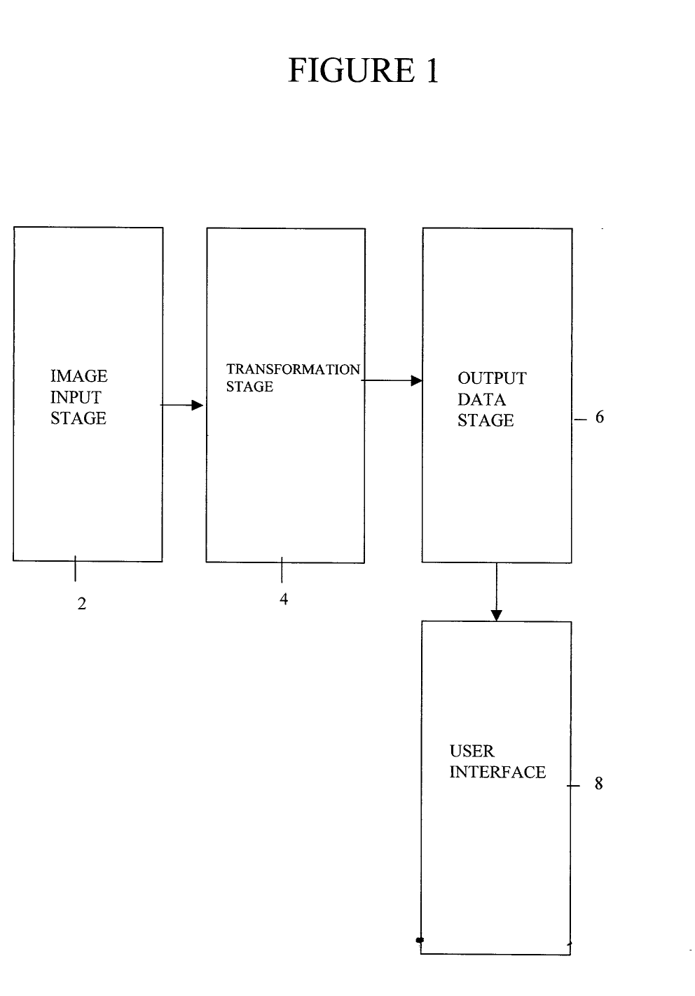

FIG. 1 is a schematic block diagram of a movement analysis system according to the teachings of the present invention. The present invention relies on the acquisition of image data to provide an accurate estimation of movement. The image input stage 2 is utilized for acquiring, obtaining or receiving image data needed for the movement analysis system. The image input stage 2 can be any device or structure suitable for receiving, obtaining or acquiring image data. The image input stage 2 can include any suitable sensor or camera for acquiring image data, or can be configured to receive image device from a remote device or network through any suitable communication link. For purposes of simplicity, we will refer to the image input stage as acquiring image data. In particular, the image input stage acquires raw 2-D coordinates of a camera used in the analysis. Also, the image input stage 2 retrieves information regarding the various parameters in the camera arrangement used to estimate human movement. The image input stage also acquires anthropometric information of the human subject used in the model.

The image data acquired by the image input stage is converged to the transformation stage 4 which utilizes the acquired image data to track and build a 3-D model of the human body. In particular, the transformation stage 4 performs the coordinate transformation needed to calculate the various kinetics and kinematics discussed in more detail below. The output data stage 6 generates output containing an array of information used in modeling human movement. In particular, the output data stage 6 provides output analysis for the various kinematic and kinetic parameters, thus allowing a more detail output of the various modeled segments acquired by the image input stage 2. The user interface 8 displays in various formats the calculated outputs of the output data stage 6. Also, the user interface 8 can also animate the human figure by way of a model (e.g. an ANDROID) in the user interface 8 based on input provided by the user or by the output data stage 6.

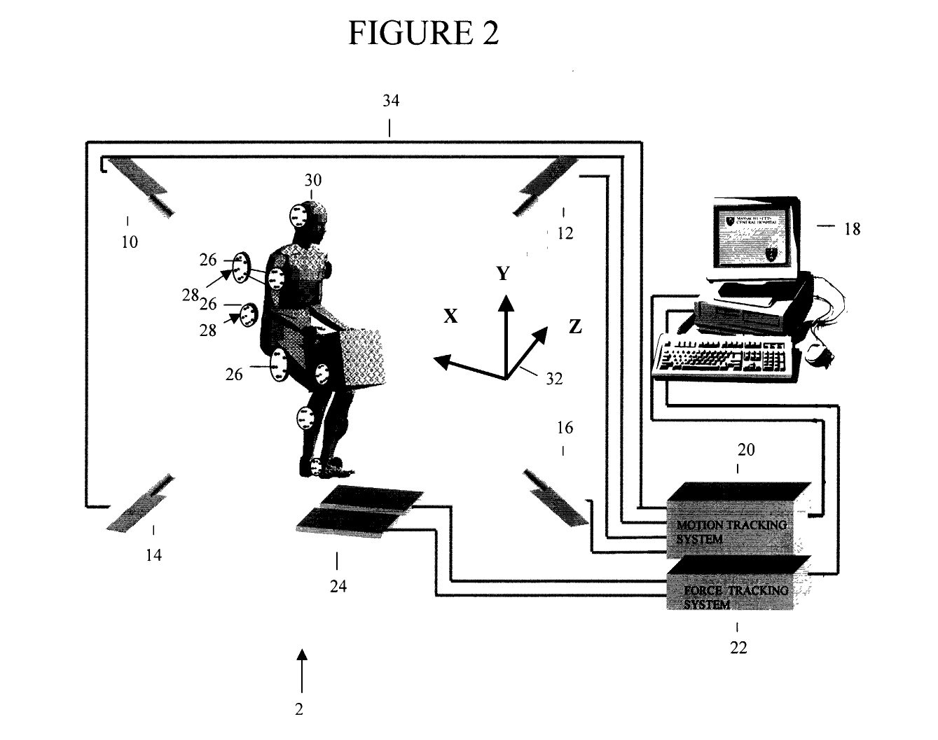

FIG. 2 is an illustrative depiction of the human modeling performed by the system of the present invention. According to one practice, the system acquires kinematic data, which is then used to estimate kinetic parameters. The image input stage can be used to acquire kinematic data, and can employ transducer/sensor systems and photographic image and reconstruction systems. It is known that electrical signals have proven to be the most reliable quantity for measuring physical information. In addition, current microelectronic technology can precisely and quickly collect, manipulate and analyze data. According to one practice, the present invention uses data captured by a set of cameras, 10, 12, 14, and 16. The acquired data is in the form of multiple, simultaneous images of the human subject 30 from various vantage points. The cameras 10, 12, 14, and 16 detect the azimuth and elevation of clusters 26 of markers 28 placed on both sides of the subject 30 to form eleven segments, including the head, trunk, pelvis, and left/right arms, thighs, shanks, and feet. One array embedded with three or more markers is rigidly fixed to each of the eleven body segments (at least three markers per array is required to define six DOF motion). For the active system shown in the example, each camera communicates directly with an optoelectric motion tracking system 20, such as a SELSPOT II, to record the positions of the array markers in 2D “internal” camera coordinates. A passive system (e.g. a video tracking system) can perform the same function, except that markers are registered by software instead of hardware. Regardless of marker registration method, the illustrated system 18 processes the signals received from each of the cameras 10, 12, 14, and 16 by transforming, frame-by-frame, the 2-D camera data into 3-D spatial coordinates in a “world” (global) coordinate system 32, and ultimately arriving at a 4-D skeletal movement kinematics and kinetics. Those of ordinary skill will readily recognize that the system can employ any suitable number of cameras. Force plates 24 controlled by the are force plate module 22, such as a KISTLER module, are an example of a peripheral device commonly integrated into the data processing stream. Other peripheral systems, such electromyography (EMG) and eye movement tracking systems, can also be integrated into the data processing stream. The acquired image data can be transferred to the image input stage 2. Alternatively, the components illustrated in FIG. 2 can comprise the image input stage 2.

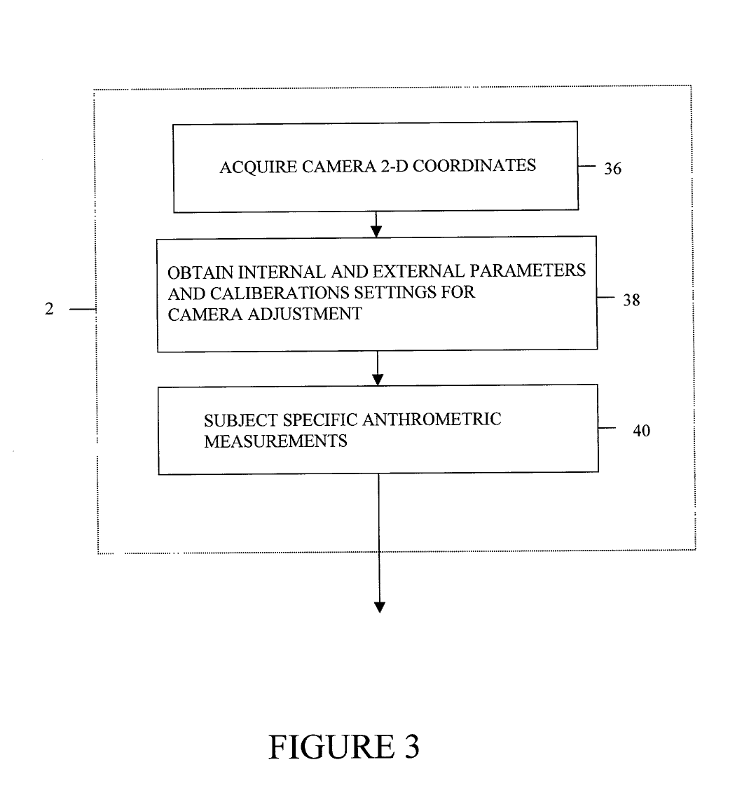

FIG. 3 is a schematic flowchart of the steps performed by the image input stage 2. The image input stage 2 acquires raw image data (e.g., marker position data in 2-D camera coordinates) and peripheral analog data (e.g., force plate data, EMG data, eye tracker data, etc.) as illustrated in FIG. 2. The raw image data is processed by the system of the present invention to determine the coordinates of the movements associated with the eleven body segments. This step can also allow the user to provide information about the relative fixed positions and orientations of the cameras, as well as about the focal length of each camera lens, as shown in step 38. An “internal” calibration routine is used to correct for non-linearity's in the lens optics, and an “external” calibration is used to convert the resulting 3-D reconstruction into global coordinates. Any calibration files for the force plates, EMG, eye tracker, and other peripherals are also entered. The image input stage 2 also allows the system to acquire anthropometric data (e.g. height, body weight, length and circumference of body segments) of the subject 30, as illustrated (step 40). The anthropometric data can be used to create subject specific 3-D body models. The system of the invention can includes a scaleable “human body”model based on polyhedral segments. The dimensions of the polyhedra are based on the subject's anthropometry entered in step 40.

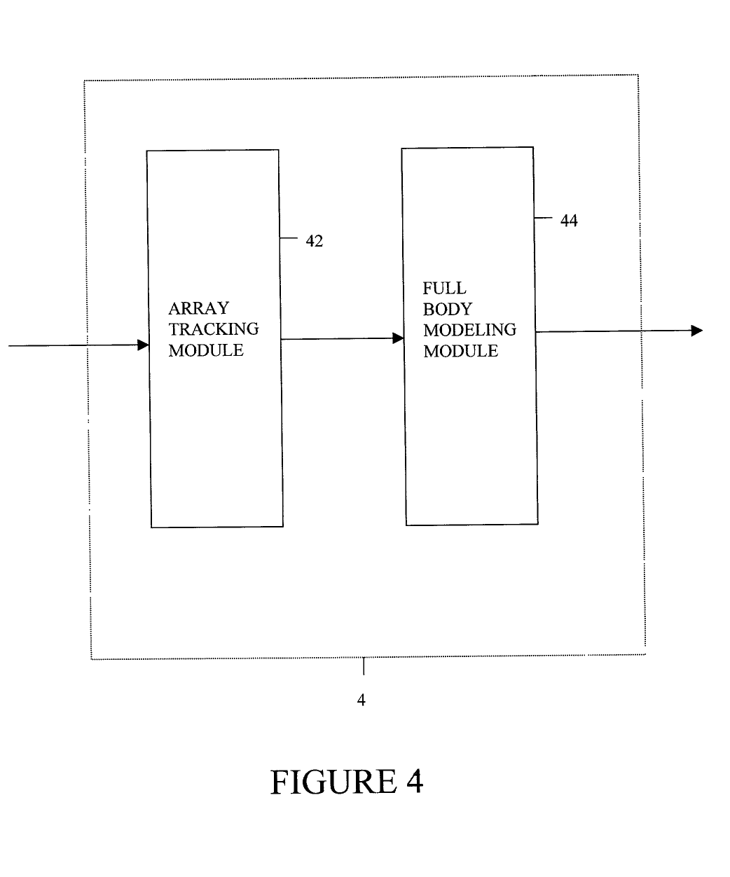

FIG. 4 illustrates a block diagram of the modules in the transformation stage 4. The transformation stage 4 includes an array tracking module 42 and a full body modeling module 44. The array tracking module 42 transforms each marker array from 2-D camera coordinates captured during movement by the image input stage tracking into 3-D (six DOF) global coordinates. The full body modeling module 44 transforms the array global coordinates into body segment, or skeletal, six DOF global coordinates. Also, the full body module integrates a set of static standing point trials with anthropometric measures obtained by the image input stage to define the transformations between the body segment-fixed arrays and the anatomical (skeletal) coordinate system of the body segment. The array tracking module 42 and the full body modeling module 44 transformations among several defined coordinate systems.

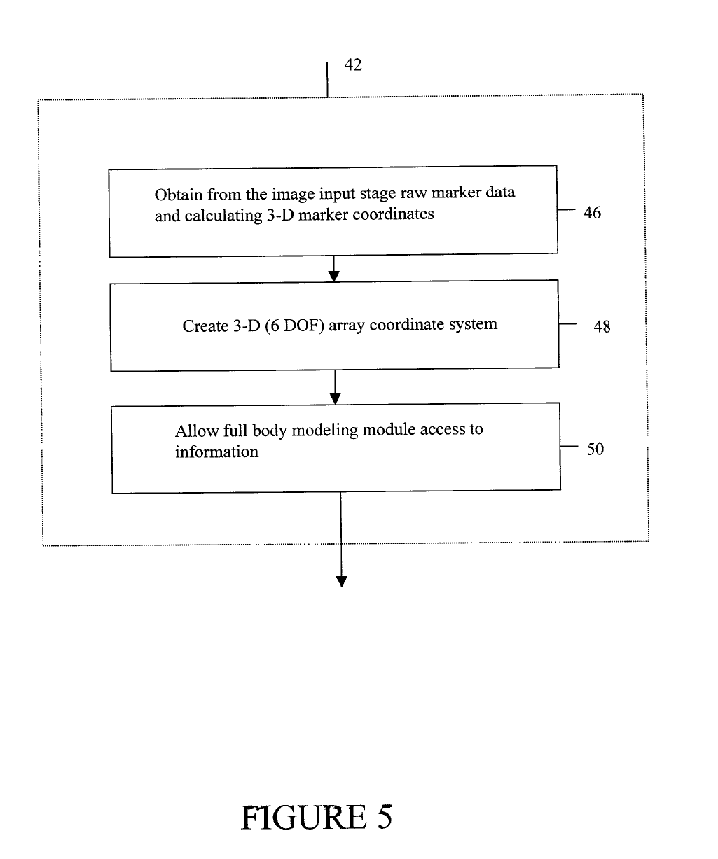

FIG. 5 is a schematic flowchart diagram illustrating the operation of the array tracking module 42. The illustrated array tracking module 42 first transforms individual markers from 2-D camera coordinates into 3-D global coordinates, as shown in step 46. Step 46 obtains the raw image data from step 36, FIG. 3. The information received by the array tracking module 42 is in 2-D camera coordinates “U” and “V”. These coordinates are corrected for non-linearity and other effects using the “internal” calibration data from step 38. The tracking module 42 then transforms the corrected 2-D camera coordinates of each marker into 3-D global coordinates using the known position, orientation, and focal length of at least two cameras, and the “external” calibration information from step 38. This is done without regard for which marker belongs to which body segment array. Once all the markers are transformed into 3-D global coordinates, the array coordinate systems are defined, step 48. First, the marker registration file (containing the information that tells the computer program which marker belongs to which array of markers) assigns marker coordinates to specific arrays, as defined by a cluster of three or more points in space. Because the markers belonging to an array are invariant relative to one another, they can be used to define a rigid plane in space, having six DOF. The method of calculating the array position and orientation is based on quaternion theory. This kinematic theory has an important advantage over conventional procedures, such as the Euler method. When deriving 3-D angles of a plane using Euler formulations, the computations become unstable at various periodic angular rotations. Quaternions do not suffer from this effect, and are stable over the full angular range of 0 to 360 degrees. Once the quaternions of the arrays are determined, they are then converted into a rotation matrix which is decomposed into Cardan angles, which is an Euler designation that specifies the order of rotations consistent with current standards of the field. After the array tracking module has assigned a global array coordinate system to all arrays 26, the full body modeling module 44 can access this information for further processing, as shown in step 50.

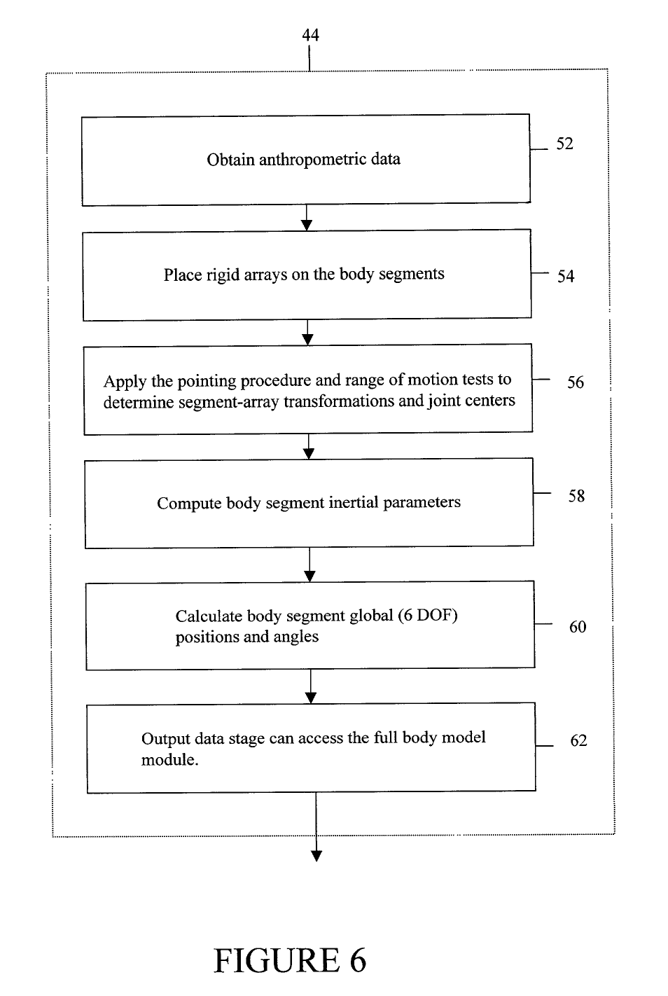

FIG. 6 is a schematic flowchart diagram illustrating the operation of the full body modeling module 44. The full body modeling module transforms array global coordinates into segment global coordinates. First, the anatomy of the subject 30 is defined using a set of standard measures, such as height, weight, body segment lengths and circumference, as shown in step 52. Next, the marker arrays 26 are employed, as shown in step 54. A series of standing pointing trials and range of motion trials are then performed, with the subject 30 in the center of the camera's viewing volume, to define the array to segment transformations and joint centers, as shown in step 56. A “pointer” consisting of markers on a rigid plate to define each segment's skeletal orientation (angles) and origin (position) in space are used. The markers on the pointer are processed exactly the same as the markers on the segment-fixed array. From this information the body segment coordinate system is defined as the array's coordinate system. Thus, at any point in time that the body segment-fixed arrays are tracked, the body segment skeletal coordinates can be calculated. The above method is also used to determine the joint centers, or the point in which any two segments rotate about each other (for example, a hinge is the joint center of a door and its frame), as shown in step 56. While most joints in the body can be treated as a hinge, the biomechanical literature is firm that the knee and hip joint do not move like hinges. Therefore, in addition to static pointing trials, a range of motion trial is performed to analytically determine the knee and hip joint centers of rotation. This is accomplished using Rodrigues vector methods, and is a procedure known to those skilled in the art. Anthropometric data, such as height, body weight, length and circumference of body segments is also obtained by the full body tracking module (step 52). The data is used to compute the inertial properties of each body segment, such as mass, center of mass and mass-moment of inertia, as shown in step 58. This data is required for kinetic analysis. The computations are based on regression formulae. Once all the parameters above in steps 56 and 58 are calculated, the positions and orientations of each body segment coordinate system can be computed in global space during any arbitrary movement trial, such as walking, climbing stairs, lifting, etc., as shown in step 60. The output data stage 6 can now access the information from the full body modeling module 44, as shown in step 62.

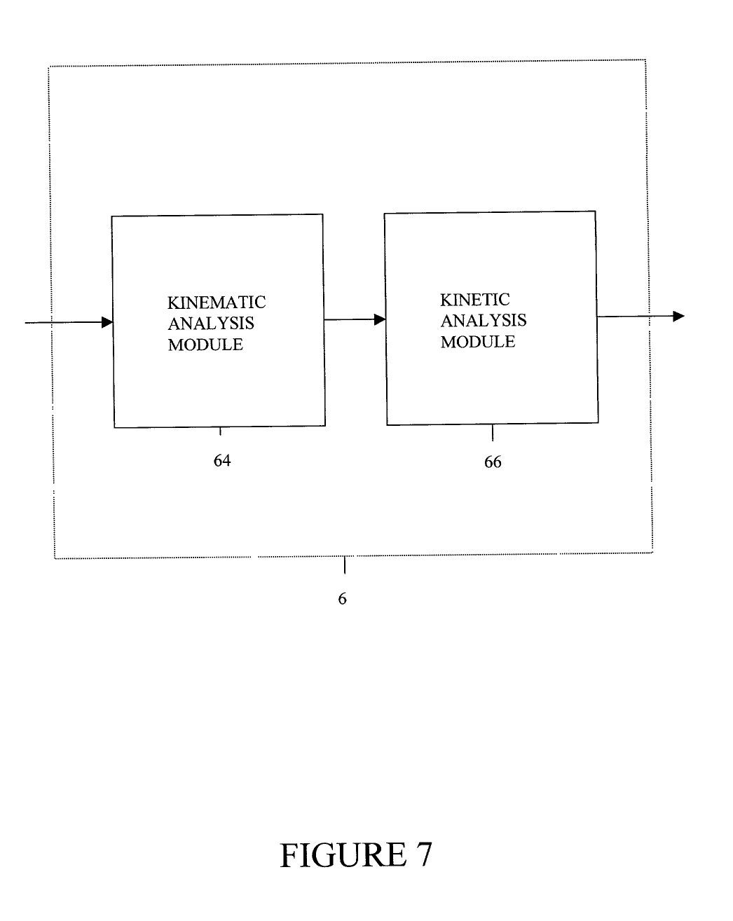

FIG. 7 is a schematic block diagram illustration of the output data stage 6 of FIG. 1. The output data stage 6 generates numerous output files containing a variety of useful biomechanical measures. In general, the output data stage 6 provides the kinematic output information and kinetic output information. The illustrated kinematic analysis module 64 provides for kinematic analysis on all of the eleven segmented body parts mentioned above. In particular, the kinematic analysis module 64 provides for a greater understanding of how the body of the subject 30 move relative to one another (coordination), as well as the rates at which they move (velocities). Thus, the kinematic analysis module 64 includes analysis information regarding the subject's bodily motions. The illustrated kinetic analysis module 66 provides for a greater understanding of how forces interact among the various body segments of the subject 30. The kinetic analysis module 66 allows the system to model the forces at the joints, and the moments (torques) applied by the muscles to move the joints . In addition, power profiles and mechanical energy expenditures of the subject 30 are computed, which offers valuable information about the subject's 30 function and compensations for disabilities.

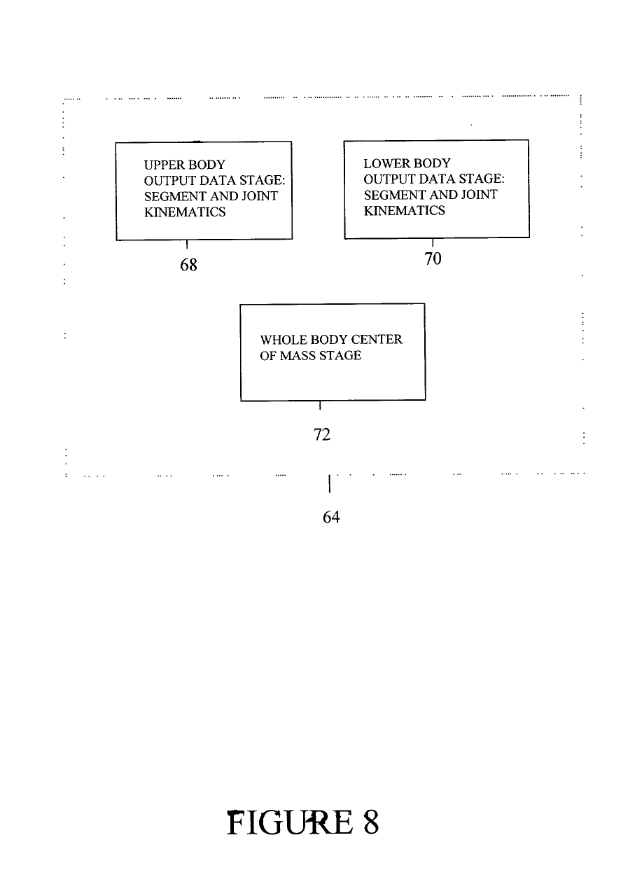

FIG. 8 is a schematic block diagram of the kinematic analysis module 64 at the output data stage 6. As stated above, the kinematic analysis module 64 provides for a greater understanding of the body segment motions. The upper body output data stage 68 provides kinematic information regarding the head, arms, trunk and pelvis of the subject 30. The upper body output data 68 determines the upper body mobility and range at the neck, shoulders and lower-back of the subject 30. The lower body output data stage 70 provides kinematic information regarding the feet, shanks and thighs of the subject 30. The lower body output data stage 70 similarly determines the lower body mobility and range at the ankles, knees and hips. The above data are useful for subjects having musculoskeletal disorders such as arthritis or joint replacements. The whole-body center of mass stage 72 enables the system to calculate the center of mass of the subject 30. The position and velocity of the center of mass of the subject 30 is useful in determining how the subject 30 controls their balance. This is especially useful for subjects that have balance disorders. The illustrated user interface 8, FIG. 1, can use the kinematic analysis module 64 to analyze virtually all aspects of the motion of the body and the body segments.

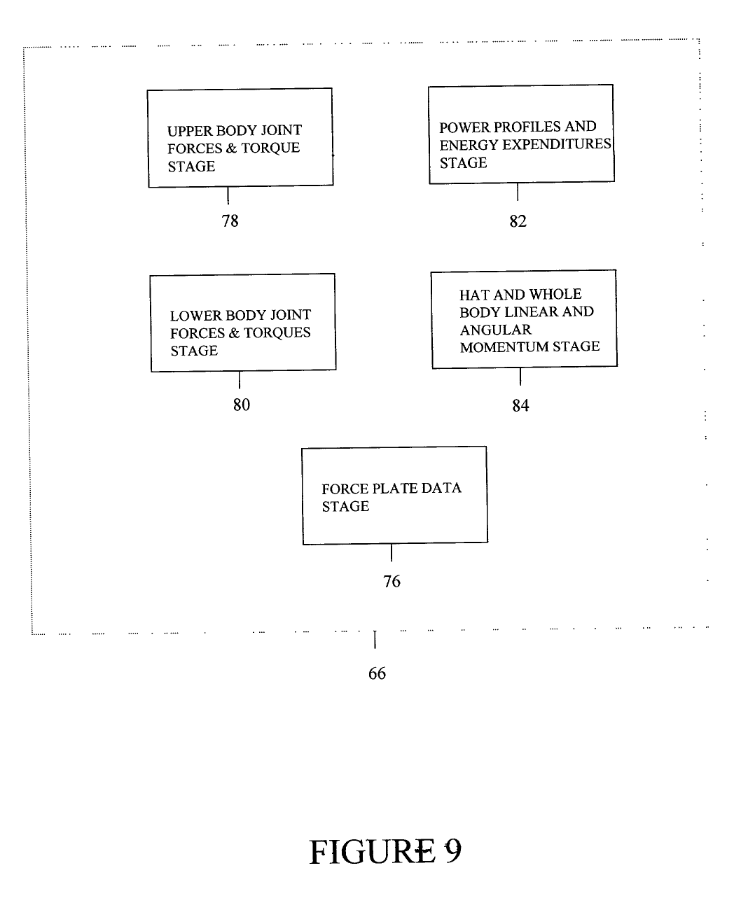

FIG. 9 illustrates a detailed depiction of the kinetic analysis module 66. As stated above, the kinetic analysis module 66 enables the system to determine the forces that interact among the various body segments of the subject 30. The force plate data stage 76 is used to determine the amount of force exerted at foot-floor contact of subject 30 while performing a task. Newtonian inverse dynamics are then used to compute the forces and torques acting at the joints of subject 30. This computation requires the data generated by the force plate data stage 76 in combination with the segment inertial properties stage 58 and the kinematics from module 64. The upper body joint force and torque stage 78 determines the forces and torque developed at the neck, shoulders, and lower-back regions. The upper body joint forces and torques are useful in evaluating injury mechanisms and treatments, and the long term effects of occupational and recreational tasks such as heavy lifting, tool manipulation and sporting activities. The lower body joint forces and torque 80 describes force and torque at the ankles, knees and hips. Lower body forces and torques 80 are useful in evaluating athletic performance during strenuous activities, and in studying joint injury mechanisms and treatments for joint degeneration disease such as arthritis. The kinetic analysis module 66 calculates power profiles and energy expenditures in the profile stage 82 for the upper and lower body segments and joints. Power and energy data are useful in evaluating the efficiency of movements during coordinated tasks, such as sporting activities for athletes, and for quantifying how subjects with disabilities compensate for their functional limitations. Also, the kinetic analysis module 66 calculates linear and angular momenta for head, arms, and trunk (HAT) and the whole-body in stage 84. This momentum analysis is useful in describing ability to control movements and maintaining balance control.

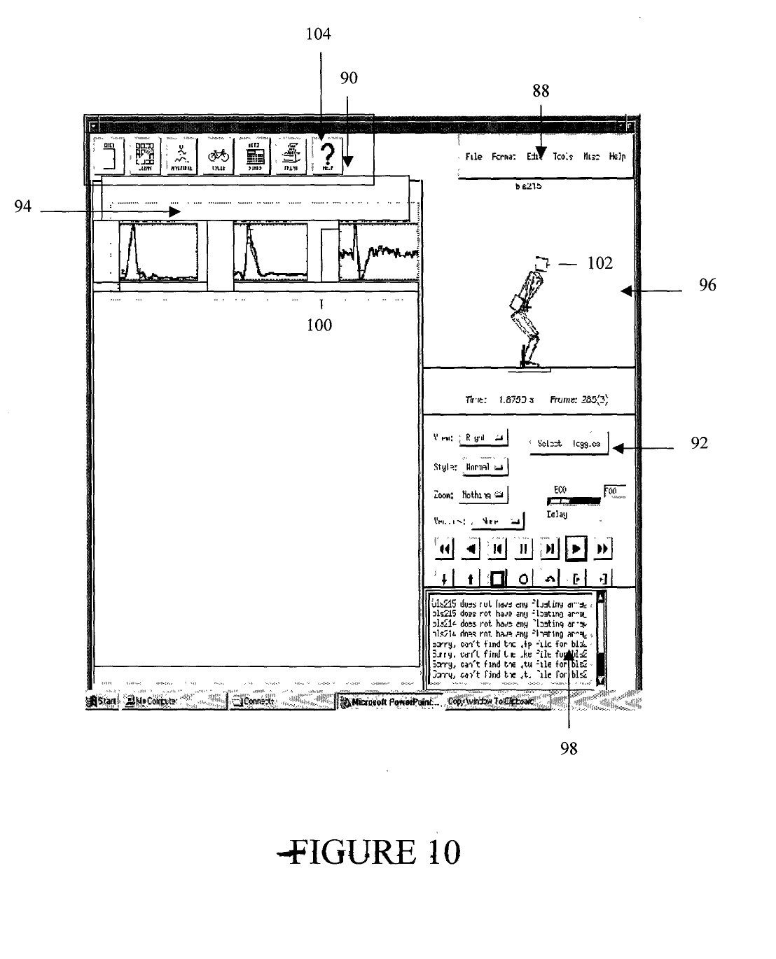

FIG. 10 is a detailed depiction of the user interface 8. The user interface 8 is a flexible tool for analyzing and displaying the output data stage 6 information. In addition to graphical display, the user interface 8 is capable of creating an animated 11 -segment human model capable of illustratively performing the stored data trials of a subject 30. The model viewing volume 96 is the area where animation occurs with an android 102. The animation tool allows complete control of the model view-point, from any elevation and azimuth. The user interface 8 also allows users to perform mathematical analyses (algebraic functions, time derivatives, and integrations), statistical analyses (means, standard deviations, root mean square), numerical analyses (digital filtering and Fourier transforms) and the like, and has many tools to aid in the interpretation of the data as well as to expedite work of the lab. The user interface screen display 86 is divided into six principle areas: the menu 88, toolbar 90, control panel 92, plot page 94, android viewing volume 96, and the text area 98. The menu 88 and toolbar 90 are at the top of the screen display 86. The right side of the window contains the model viewing volume 96, the control panel 92 and the text area. To return to the plot page 94, click on the 'Dismiss′ button at the top of the page. The menu 88 organizes the commands into logical groups. The menu items include an ellipse for indicating that the item opens text boxes and buttons on the control panel which must be used to complete the command. It offers sub-options within the function initially indicated. For instance, the “Load form” item creates 5 text boxes and 7 buttons including boxes for the Trial and Form buttons for loading and displaying trial data in the directory file (a list of trials available for subject 30). The Form feature is used to create a template of plots (any desired combination of kinematic and kinetic data) that can be used for any subject's data. The toolbar 90 contains buttons that input into a control panel before they complete execution. The plot page 94 is the area where tracks 100 (data associated with elements of the kinematic and kinetic analysis module 64 and 66), are displayed as high resolution plots. In particular, the user interface 8 provides various detailed plots of the various elements in the kinematic analysis module 64 and kinetic analysis modules 66. Each group of tracks 100 is custom displayed on its own plot. The user can zoom (enlarge to the full size of the plot page 94) any plot with a single mouse click, and then perform various detailed analyses on the data with additional single mouse clicks, such as picking off maximums and minimums or values at user specified times. The user can also specify a window of data to concentrate the analysis, and rescale the data in the window to a movement cycle (0-100%). This feature is particularly useful in analyzing cyclic movements such as gait. Output data from user controlled analyses appear in the text window 98, as well as helpful hints to the user when improper procedures are used or other user errors occur. A fully functional Help 104 facility is available to the user to explain the various features of the interface.

The user interface can also be used to generate movement tracing, or overlays, and as a framed strip to examine sequential movements in relation to one another. This is particularly useful for generating reports and publication material where a series of events is being depicted.

Numerous modifications and alternative embodiments of the invention will be apparent to those skilled in the art in view of the foregoing description. Accordingly, this description is illustrative only and is for the purpose of teaching those skilled in the art the best mode for carrying out the invention. Details of the structure may vary substantially without departing from the spirit of the invention, and exclusive use of all modifications that come within the scope of the appended claims is reserved. It is intended that the invention be limited only to the extent required by the appended claims and the applicable rules of law.

Having described the invention, what is claimed as new and protected by Letters Patent is:

1. A system for displaying kinematic and kinetic information of a subject, comprising:
an image input stage for acquiring image data of the subject;
a transformation stage for transforming the image data into three dimensional coordinates corresponding to one or more body segments of the subject; and
an output data stage for calculating the kinematic and kinetic information of the subject from the three dimensional coordinates.

2. The system of claim 1, further comprising a user interface for displaying the calculated kinematic and kinetic information of the subject.

3. A method for displaying kinematic and kinetic information of a subject, said method comprising:
acquiring image data of the subject;
transforming the image data into three dimensional coordinates corresponding to one or more body segments of the subject; and
calculating the kinematic and kinetic information of the subject from the three dimensional coordinates.
